(19) United States
(12) Patent Application Publication
(10) Pub. No.: US 2009/0132752 A1
(43) Pub. Date: May 21, 2009

(54) Interface for Non-Volatile Memories

(75) Inventors: Teng Pin Poo, Singapore (SG); Henry Tan, Singapore (SG)

Correspondence Address: JACOBSON HOLMAN PLLC, 400 SEVENTH STREET N.W., SUITE 600, WASHINGTON, DC, 20004, US

(73) Assignee: TREK 2000 INTERNATIONAL LTD, Singapore (SG)

(21) Appl. No.: 11/886,656

(22) PCT Filed: Mar. 24, 2006
(86) PCT No.: PCT/SG2006/000072

§ 371 Date: Nov. 13, 2008

(30) Foreign Application Priority Data
Apr. 19, 2005 (SG) 200502382-5

(51) Int. Cl. G06F 12/02; G06F 12/00

(52) U.S. Cl. 711/103; 711/112; 711/E12.001; 711/E12.008

(57) ABSTRACT

A portable storage device for storage of data. The portable storage device comprises a first non-volatile memory of a first character; a second non-volatile memory of a second character, the second character being different to the first character; and a controller for determining to which of the first and second non-volatile memory the data is to be sent. The determining is based on a defined relationship between the first and second non-volatile memories, the defined relationship being buffer or backup.

### FIELD OF THE INVENTION

This invention relates to an interface for non-volatile memories and refers particularly, though not exclusively, to an interface between non-volatile memories of different categories.

### BACKGROUND OF THE INVENTION

Portable memory devices such as, for example, flash drives, thumbdrives, and MP3 players, often have memory of a single character. It is not possible to have two or more memories of a difference character such as, for example, flash memory and a hard disk drive, in such devices.

### SUMMARY OF THE INVENTION

In accordance with a first preferred aspect there is provided a portable storage device for storage of data, the portable storage device comprising:
(a) a first non-volatile memory of a first character;
(b) a second non-volatile memory of a second character, the second character being different to the first character; and
(c) a controller for determining to which of the first and second non-volatile memory the data is to be sent.

The determination may be based on a defined relationship between the first and second non-volatile memories. The relationship may be that the first non-volatile memory is a buffer or a backup for the second non-volatile memory. The relationship may be preset, or may be user set.

The first non-volatile memory may be a flash memory, and the second non-volatile memory may be a hard disk drive. The controller may comprise at least one of a flash controller, a hard disk controller and a bridge controller. The bridge controller may comprise a flash-to-hard-disk-drive controller.

The hard disk may further comprise an integrated device electronics interface. The controller may comprise a flash memory controller and a hard disk drive controller.

The bridge controller and the flash memory may be on the same bus. The bridge controller may be a dedicated controller for reading address data, and the data, from the flash memory, and for writing the data to the hard disk drive.

According to a second aspect there is provided a method for storing data in a portable storage device, the portable storage device comprising:
(a) a first non-volatile memory of a first character;
(b) a second non-volatile memory of a second character, the second character being different to the first character; and
(c) a controller for determining to which of the first and second non-volatile memory the data is to be sent;

the method comprising:
(d) determining a relationship between the first and second non-volatile memories and sending the data based on that relationship.

The relationship may be one of: the first non-volatile memory is a data buffer for the second non-volatile memory, and the first non-volatile memory is a data backup for the second non-volatile memory.

For both aspect the data may be first stored in the first non-volatile memory, then stored in the second non-volatile memory; the first non-volatile memory being a data buffer for the second non-volatile memory. Alternatively or additionally, the first non-volatile memory may be a data backup for the second non-volatile memory. In such a case, the data may be stored in the first and second non-volatile memories sequentially or simultaneously.

The first non-volatile memory controller was first send the data to the controller, and the controller may convert the data for storage on the second non-volatile memory.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings.

In the drawings:

FIG. 1 is a block diagram of a first embodiment;

FIG. 2 is a block diagram of a second embodiment;

FIG. 3 is a block diagram of a third embodiment; and

FIG. 4 is a flow chart for the preferred method.

### DETAILED DESCRIPTION OF THE PREFERRED EMBODIMENTS

The embodiments illustrate structures and various methodologies for interfacing between a first form or category of a non-volatile memory such as, for example, a hard disk drive, and a second form or category of non-volatile memory such as, for example, a solid state memory. The solid state memory may be a flash memory.

The interfacing is based on a defined relationship between the two memories. The relationship may be backup, or buffer. The relationship may be preset, or may be user set or selected.

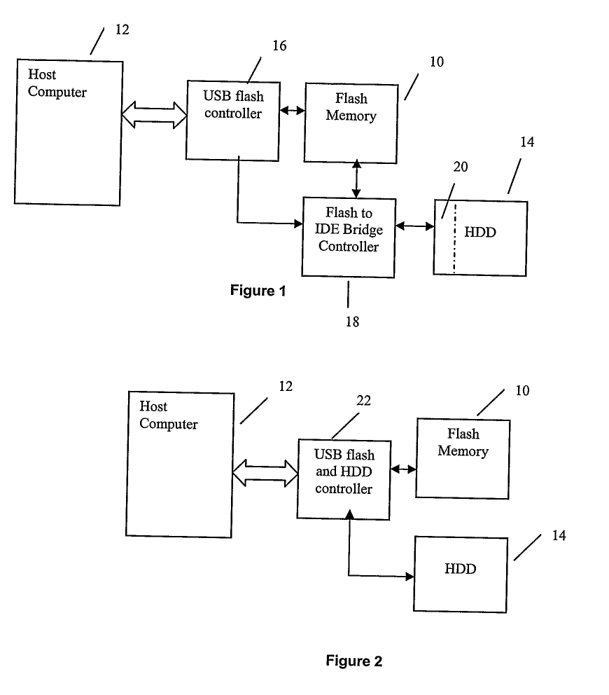

In FIG. 1 there is a flash memory 10 acting as a data buffer during a data transfer from host computer 12 to the hard disk drive 14 or from the hard disk drive 14 to the host computer 10. During downloading, the data will flow from the host computer 12 to the USB flash controller 16. The function of the flash controller 16 is to store data to the flash memory 10; and to store to the flash memory the address data being where the data will be stored on the hard disk drive 14. The USB flash controller 16 then sends a signal to the flash-to-bridge controller 18 to initiate data transfer from flash memory 10 to hard disk drive 14. The data transfer then takes place. The bridge controller 18 includes a disk drive interface 20 that may be an integrated device electronics (“IDE”) device. The bridge controller 18 is a dedicated controller to read the address data, and the data, from the flash memory 10 and to write it to the hard disk drive 14 via the interface 20 of the hard disk drive 14. The hard disk drive 14 interface 20 may be an IDE interface, ATA, Serial ATA or Compact flash Type II interface.

In FIG. 2 the flash memory 10 is for data backup. When data flows from the host computer 12 to the combined USB flash and hard disk drive controller 22, it will be written to both the hard disk drive 14 and the flash memory 10. When reading the data, the user will have the option of reading from the hard disk drive 14 or the flash memory 10. The default setting for the reading of data will be from the hard disk drive 14. Data may be written to one storage medium at a time: flash memory 10 and hard disk drive 14 sequentially. This may be hard disk drive 14 first then flash memory 10 or, as illustrated, flash memory 10 then hard disk drive 14. The data is first completely downloaded to one and, when that download is completed, backed-up to the other. This may be on the basis of all data (backup after all data is the first) or on a file-by-file basis (backup after each file).

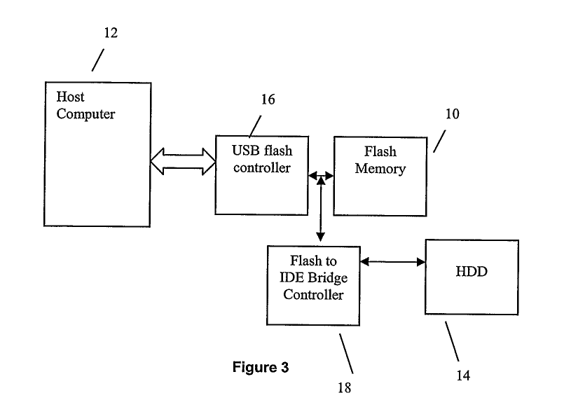

FIG. 3 show where data can be written into flash memory 10 and hard disk drive 14 simultaneously. Here, the data will flow from host computer 12 to the USB flash controller 16 and then to both the flash memory 10 and the flash-to-IDE bridge controller 18 at same time. The IDE bridge controller 18 will then interpret the flash memory command and convert it to an IDE command to store the data to the hard disk drive 14. In this case the data can be written simultaneously to the flash memory 10 and hard disk drive 14. The bridge controller 18 and the flash memory 10 may be on the same bus.

When uploading data from hard disk drive 14 and/or flash memory 10, the reverse process takes place.

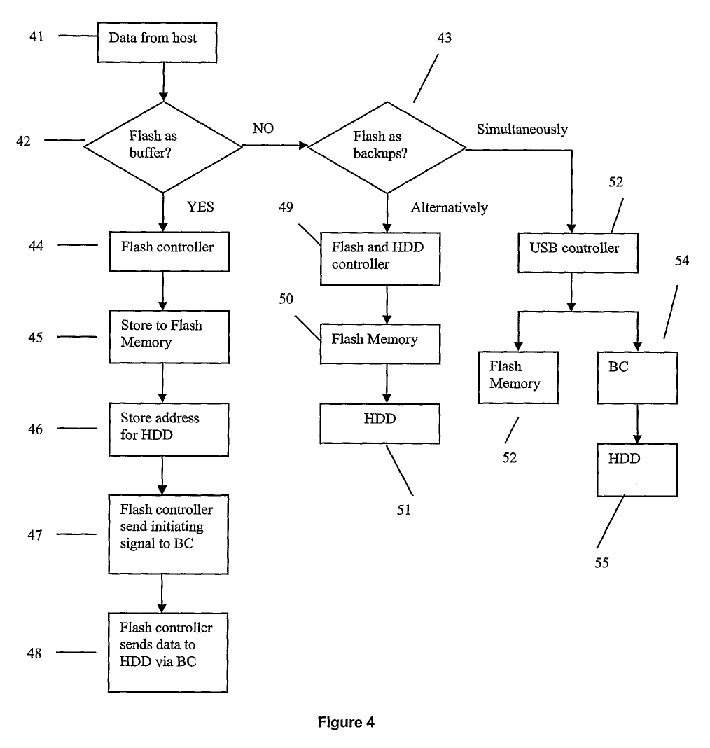

Referring to FIG. 4, the process is that when data download is initiated (41) the relationship between the hard disk drive 14 and flash memory 10 is important. This may be pre-set, or user defined. If user defined, the user selects buffer (42) or backup (43). If backup (43), it may be either alternatively, or simultaneously. For buffer (42), the flash controller 16 operates (44) to store the data to the flash memory 10 (45) and stores the address data relating to the address on the hard disk drive for the data (46).

The flash controller 16 then sends an initiating signal to the bridge controller 18 (47), and the data to the hard disk drive 14 via the bridge controller 18 (48).

For backup (43), if alternatively, the data is processed by the flash and hard disk drive controller 22 (49) and stored to the flash memory 10 (50). From the flash memory 10 it is stored to the hard disk drive 14 (51). The storage steps 50 and 51 may be in the reverse order with storage being first to hard disk drive 14 then to flash memory 10. The second storage (backup) is after storage to the first is complete. This may be for the complete data, or on a file-by-file basis.

For backup (43), if simultaneously, the USB controller 16 sends the data (52) simultaneously to the flash memory 10 (53) and the bridge controller 18 (54) for the hard disk drive 14.

Naturally, if preset the process will go directly from the data step (41) to one of steps 44, 49 and 52 according to the preset relationship.

Whilst there has been described in the foregoing description preferred embodiments of the present invention, it will be understood by those skilled in the technology concerned that many variations or modifications in details of design or construction may be made without departing from the present invention.

1. A portable storage device for storage of data, the portable storage device comprising:
(a) a first non-volatile memory of a first character;
(b) a second nonvolatile memory of a second character, the second character being different to the first character; and
(c) a controller for determining to which of the first and second non-volatile memory the data is to be sent.

2. A portable storage device as claimed in 1, wherein the first non-volatile memory is a flash memory, and the second non-volatile memory is a hard disk drive.

3. A portable storage device as claimed in claim 2, wherein the controller comprises at least one of: a flash controller, a hard disk controller, and a bridge controller.

4. A portable storage device as claimed in claim 2 or claim 3, wherein the bridge controller comprises a flash to hard disk drive controller.

5. A portable storage device claimed in claim 4, wherein the hard disk comprises an integrated device electronics interface.

6. A portable storage device as claimed in claim 2 or claim 3, wherein the controller comprises a flash memory controller and a hard disk drive controller.

7. A portable storage device is claimed in any one of claims 1 to 6, wherein the determining is based on a defined relationship between the first and second non-volatile memories, the defined relationship being selected from the group consisting of: buffer, and backup.

8. A portable storage device as claimed in claim 7 wherein the defined relationship is selected from the group consisting of: user set, and preset.

9. A portable storage device as claimed in any one of claims 1 to 6, wherein the data is first stored in the first non-volatile memory then in the second non-volatile memory, the first non-volatile memory being a data buffer for the second non-volatile memory.

10. A portable storage device as claimed in any one of claims 1 to 6, wherein the first non-volatile memory is a data backup for the second non-volatile memory, the data being stored in the first and second non-volatile memories sequentially or simultaneously.

11. A portable storage device as claimed in claim 10 when appended to claim 3, wherein the bridge controller and the flash memory are on the same bus.

12. A portable storage device as claimed in claim 3, wherein the bridge controller is a dedicated controller for reading address data as well as the data from the flash memory, and for writing the data to the hard disk drive.

13. A method for storing data in a portable storage device, the portable storage device comprising:
(a) a first non-volatile memory of a first character;
(b) a second non-volatile memory of a second character, the second character being different to the first character; and
(c) a controller for determining to which of the first and second non-volatile memory the data is to be sent;
the method comprising:
(d) determining a relationship between the first and second non-volatile memories and sending the data based on that relationship.

14. A method as claimed in claim 13, wherein the relationship is one of: the first non-volatile memory is a data buffer for the second non-volatile memory, and the first non-volatile memory is a data backup for the second non-volatile memory.

15. A method as claimed In claim 12, wherein the data is first stored in the first non-volatile memory then in the second non-volatile memory, the first non-volatile memory being a data buffer for the second non-volatile memory.

16. A method as claimed in claim 13, wherein the first non-volatile memory is a data backup for the second non-volatile memory, the data being stored in the first and second non-volatile memories sequentially or simultaneously.

17. A method as claimed in any one of claims 12 to 16, wherein the controller comprises at least one of: a flash controller, a hard disk controller, and a bridge controller.

18. A method as claimed in 13 or claim 14, wherein the first non-volatile memory controller first sends the data to the controller, and the controller converts the data for storage on the second non-volatile memory.

19. A method as claimed in any one of the claims 12 to 8, wherein the first non-volatile memory is a flash memory, and the second non-volatile memory is a hard disk drive.

20. A method as claimed in any one of claims 13 to 19, wherein the relationship is selected from the group consisting of: user set, and preset.
